(19) United States
(12) Patent Application Publication
(10) Pub. No.: US 2010/0093271 A1
(43) Pub. Date: Apr. 15, 2010

(54) Method and Apparatus to Facilitate Selection of a Particular Alert Modality

(75) Inventors: Steven J. Nowlan, South Barrington, IL (US); Mark A. Gannon, Sleepy Hollow, IL (US); Louis J. Vannatta, Crystal Lake, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/251,214

(22) Filed: Oct. 14, 2008

(51) Int. Cl. H04H 20/71

(52) U.S. Cl. 455/3.01

(57) ABSTRACT

Upon determining (101) that a given end user content delivery apparatus (200) that is presently delivering content using a first end user-perceivable modality is about to change to delivery of the content using a second end-user perceivable modality that is different from the first end user-perceivable modality, selecting (102) a particular alert modality (from amongst a plurality of available candidate different alert modalities for the given end user content delivery apparatus) to be employed to alert the end user regarding the change from the first end user-perceivable modality to the second end user-perceivable modality as a function, at least in part, of a measure of saliency as pertains to each of the plurality of available candidate different alert modalities.

### TECHNICAL FIELD

This invention relates generally to end user content delivery systems and more particularly to the provision of an alert to an end user regarding a change from one end user-perceivable modality to another.

### BACKGROUND

The Open Mobile Alliance (OMA) proposes the use of so-called Dynamic Profile Evolution (DPE) to facilitate the delivery of rich content to an end user device such as a wireless portable two-way communications platform. By one approach, this can comprise changing the delivery of content to an end user from a first end user-perceivable modality to a second end user-perceivable modality that is different from the first modality. Using DPE, for example, a receiving end user device can request that a content-providing service provider modify presently streaming content into a different format in order to better accommodate a changing operational and/or content-consuming environment or preference as corresponds to the end user device. By way of illustration, this might comprise switching from a text-based feed of sports highlights on a display to an audibilized stream of that same information.

In some cases, such a change with respect to content-delivery modality is preceded and/or accompanied by a corresponding alert. The purpose of this alert is to provide notice to the end user regarding the impending, occurring, and/or effected modality change. This might comprise, for example, providing a particular audible tone to alert the end user of such a change.

Unfortunately, the flexibility with respect to content-rendering modalities supported and enabled by standards such as DPE can give rise to new corresponding problems. For example, the aforementioned alert may, or may not, be effective in a given application setting to successfully alert the end user to such a change. Instead, in many cases, it is quite possible for the alert to be delivered via a modality that is too readily missed or ignored by the end user. When this occurs, the end user, in turn, can become confused, puzzled, and/or distracted by the content-delivery modality change. This, in turn, can lead to considerable dissatisfaction on the part of the end user.

### BRIEF DESCRIPTION OF THE DRAWINGS

The above needs are at least partially met through provision of the method and apparatus to facilitate selection of a particular alert modality described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, these teachings will provide for determining that a given end user content delivery apparatus that is presently delivering content using a first end user-perceivable modality is about to change to delivery of the content using a second end-user perceivable modality that is different from the first end user-perceivable modality. When this occurs, these teachings then provide for automatically selecting a particular alert modality (from amongst a plurality of available candidate different alert modalities for the given end user content delivery apparatus) to be employed to alert the end user regarding the change from the first end user-perceivable modality to the second end user-perceivable modality as a function, at least in part, of a measure of saliency as pertains to each of the plurality of available candidate different alert modalities.

These teachings are suitable for use with a plurality of different available candidate alert modalities. Examples include, but are not limited to, visually perceivable alert modalities, audibly perceivable alert modalities, and/or haptically perceivable alert modalities. These teachings will also accommodate determining a measure of the aforementioned saliency in order to permit the use of that measure as described. By one approach, this measure can be determined as a function of the first end user-perceived modality, the second end user-perceived modality, or both. By one approach, this measure can reflect a measure of end user perceptual contrast for a given one of the available candidate different alert modalities as compared to one or both of these end-user perceived modalities. By one approach these teachings can provide for selecting a particular alert modality (using this measure of saliency) by selecting a particular alert modality with an eye towards minimizing orthogonality between the particular alert modality and the first end user-perceivable modality while also selecting the particular alert modality to maximize end user perceptual contrast.

So configured, those skilled in the art will recognize and appreciate that an alert can be usefully and reliably provided to an end user to announce a change with respect to the modality of presently-delivered content in manner that is considerably more likely to effect and achieve the intended purpose of that alert. In particular, these teachings greatly enhance the opportunity for the end user to in fact perceive the alert and to comprehend its meaning in a given application setting. Those skilled in the art will appreciate that these teachings are readily leveraged to accommodate existing practices and technologies. It will also be understood and appreciated that these teachings are highly scalable and will accommodate a wide variety of candidate alert modalities and content-delivery modalities.

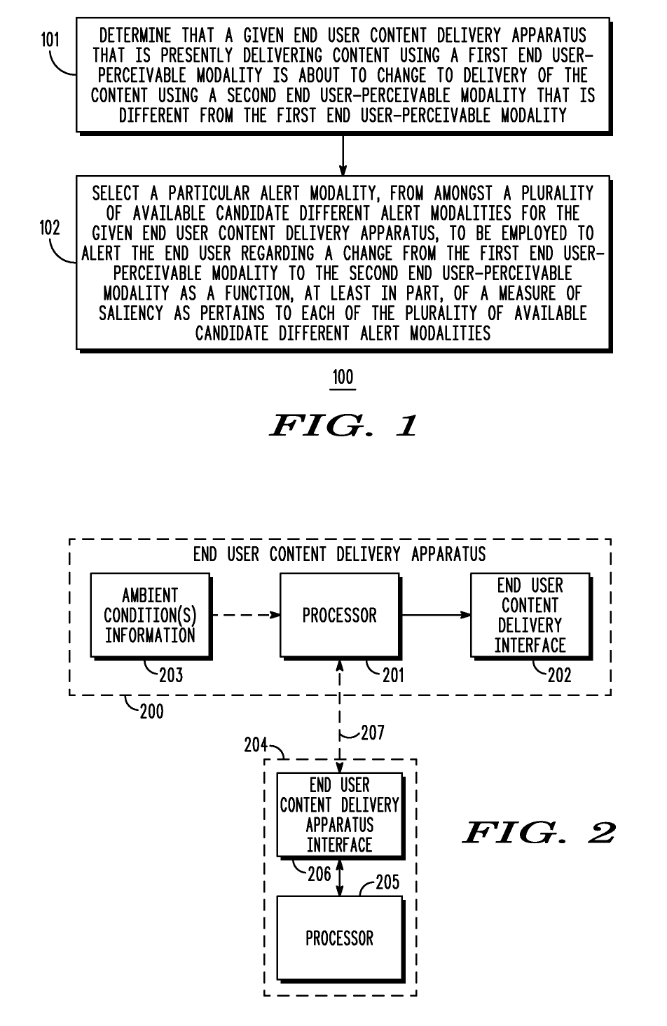

These and other benefits may become clearer upon making a thorough review and study of the following detailed description. Referring now to the drawings, and in particular to FIG. 1, an illustrative process that is compatible with many of these teachings will now be presented.

Pursuant to this process 100, an enabling platform determines 101 that a given end user content delivery apparatus that is presently delivering content using a first end user-perceivable modality is about to change to delivery of the content using a second end user-perceivable modality that is different from the first end user-perceivable modality. Those skilled in the art will recognize that there are various way by which this step can be carried out.

For example, by one approach, the content server which is providing the presently delivered content (which may be physically remote from the aforementioned enabling platform) can be aware of this change and can provide a corresponding alert and/or instruction to the enabling platform. Reception of this alert/instruction can hence comprise the aforementioned determination step 101.

As another example in this regard, the enabling platform in some application settings will negotiate and/or otherwise interact with the content server to thereby initiate or otherwise facilitate this change in delivery modality. In cases such as these, if desired, the enabling platform can be self-aware of the impending change in modality and this, in turn, can comprise the aforementioned determination step 101. As another related example, the end user device may determine that its own operating context has changed in some particular way (by noting, for example, that background noise has increased considerably). In such a case, the end user device can communicate this information to the content server. The latter can then, if desired, calculate a corresponding change of modality and provide the end user device with the resultant change information.

As yet another example in this regard, an intervening network or network element (such as, for instance, an intervening wireless network such as a cellular telephony network) may be aware of the impending change due to corresponding altered-modality negotiations with the content server (to accommodate, for example, network loading issues). In such a case, the intervening network can provide a corresponding notice to the enabling platform in these regards. Those skilled in the art will recognize that other possibilities in these regards exist as well and that other possibilities are likely to be developed going forward.

This process 100 then provides for responsively and automatically selecting 102 a particular alert modality, from amongst a plurality of available candidate different alert modalities for the given end user content delivery apparatus, to be employed to alert the end user regarding a change from the first end user-perceivable modality to the second end user-perceivable modality as a function, at least in part, of a measure of saliency as pertains to each of the plurality of available candidate different alert modalities. These alert modalities can vary considerably from one application setting to another as will be well understood by those skilled in the art.

This process 100 will readily accommodate, for example, a plurality of different visually perceivable alert modalities (such as, by way of illustration and not by way of limitation, text-based modalities, monochromatic-based modalities, full color-based modalities, still image-based modalities, video-based modalities, and so forth). This process 100 will also accommodate, and again by way of example and either alone or in combination with the foregoing, a plurality of different audibly perceivable alert modalities (such as, and again by way of illustration and not by way of limitation, ordinary spoken word-based modalities, non-verbal alert tone or sound-based modalities, musically-based modalities, and so forth). As yet another example, and again in lieu of the above or in combination therewith, this process 100 will further accommodate a plurality of different haptically perceivable alert modalities (such as, and again by way of illustration and not by way of limitation, thermally-based modalities, vibration-based modalities, pressure-based modalities, and so forth).

Those skilled in the art will recognize that such modalities are well understood in the art. It will further be understood that these teachings are not overly sensitive to any particular selections in these regards. Accordingly, for the sake of brevity and clarity, further elaboration in these regards will not be provided save for when appropriate to the needs of a particular illustrative example.

As used here, this reference to “candidate” different alert modalities will be understood to refer to different modalities that are genuinely available for selection for use. Accordingly, a given modality that, while perhaps technically present in a given end user content delivery apparatus but that is not actually usable for whatever reason will be understood to not comprise a candidate modality for these purposes. Also as used here, this reference to an “available” candidate different alert modality will be understood to refer to a modality that is, in fact, on hand in a form that is suitable for use and implementation by the given end user content delivery apparatus.

As noted, this step provides for taking into account a measure of saliency as pertains to each of the plurality of available candidate different alert modalities. The word “salient,” of course, refers to something which possesses a quality that thrusts itself into attention. Accordingly, as used herein, this reference to “saliency” will be understood to refer to a characteristic (or characteristics) of a given alert modality that will attract and draw the cognitive attention of an end user to the present existence and meaning of the corresponding alert. (The interested reader may find S.-C. Yen and Leif Finkel, “Extraction of perceptually salient contours by striate cortical neurons”, Vision Research, vol. 38, no. 5, pp. 719-741, 1998 to be of interest in these regards.)

There are various way by which such a measure can be ascertained. By one approach, for example, this measure can be determined as a function of the first end user-perceivable modality and/or the second end user-perceivable modality. In particular, this can comprise, for example, taking into account the orthogonality and/or the perceptual contrast as pertains to the alert modality candidates in comparison to the presently used and/or about-to-be-used content delivery modality. Generally speaking, this step of selecting 102 a particular alert modality can comprise selecting a particular alert modality that minimizes orthogonality between the particular alert modality and, for example, the first end user-perceivable modality and that maximizes end user perceptual contrast. (Those skilled in the art will recognize that “perceptual contrast” comprises a known area of endeavor. For example, K-C. Liu and C-H. Chou, “Perceptual Contrast Estimation for Color Edge Detection”, 14^{th} International IEEE Workshop on Speech and Image Processing and Multimedia Communications Services”, pp. 86-89, 2007 serves as one example of how perceptual contrast can be defined and measured for a specific type of modality.)

Generally speaking and in many application settings, the more orthogonal the modalities are to one another, the more likely it is that the end user will not be suitably cognitively engaged to perceive and appreciate the alert. For example, when a present content delivery modality relies completely upon streaming audio comprising spoken words, a highly orthogonal delivery modality such as a scrolling line of text on a display is likely to be unviewed by the end user. In such a case, delivering the alert via that scrolling line of text is similarly unlikely to be successful as an alert mechanism. Conversely, and again in many application settings, the more non-orthogonal the modalities are to one another, the more likely that the end user will be cognitively engaged in a manner that is conducive to perceiving the alert. To refer to the example just provided, using a highly non-orthogonal delivery modality such as a particular audio tone to announce the alert is considerably more likely to be perceived by the end user who is cognitively engaged in listening to the spoken word audio stream.

As noted, this selection 102 of a particular alert modality can also (or in lieu of considering orthogonality) take into account the amount of perceptual contrast as pertains to the candidate alert modalities as another component of this measure of saliency. It is possible for a given alert modality to be highly perceptually contrastive (or not) regardless of the degree of orthogonality that may apply in a given example. As one example, a display that is providing delivered content and which suddenly begins blinking on and off using an unusual color to provide the alert is likely to be noticed by the end user both because the alert modality is non-orthogonal to the primary content delivery modality and because there is a high amount of perceptual contrast in this case.

Again, although these teachings will accommodate measuring saliency as a function only of perceptual contrast or of orthogonality, for many application settings it may be particularly useful to take both such criterion into account. This will tend, in turn, to assure both that the alert will be delivered in a way that coincides with the end user's present cognitive processing and in a way that is contrastive enough to be likely independently discerned and comprehended.

There are various ways by which the aforementioned steps can be accomplished. As one particular example in this regard (which is offered without intending any particular limitations in this regard), these teachings will accommodate constructing a perceptual space vector for the currently employed content delivery modality. This vector can serve to map the current content modality into a high dimension space that reflects psychophysical measures of perceptual orthogonality. These teachings will then further accommodate also constructing a perceptual contrast vector for each modality currently being used to delivery content (as numerous modalities may in fact be simultaneously employed at a given time). This vector can constitute a measurement, for example, of perceptual dimensions for a particular modality (for components such as visual contrast, brightness, and spatio-temporal energy distribution for a given visual percept).

A given alert modality can then be selected which maximizes the combination of modal non-orthogonality and perceptual contrast. This might comprise, for example, computing a metric such as:

((CPSV@APSV)*(CCV@ACV)) (1)

where CPSV is the content perceptual space vector, APSV is the alert perceptual space vector, CCV is the content contrast vector, and ACV is the alert contrast vector. (In this expression, the symbol “@” will be understood to represent a generalized vector dot product while “*” represent scalar multiplication.) Using this approach to the measurement of saliency, one could then make the final selection by picking the alert modality that maximized the metric represented by expression 1 shown above.

Potentially useful examples in such regards might include: using a combination of vibratory and flashing light alerts when announcing a change to a content delivery modality that currently comprises an audio-only mode of delivery; using a bold font text overlay alert when announcing a change to a content delivery modality that currently comprises a streaming video feed; or using an auditory alert when announcing a change to a content delivery modality that currently comprises a text delivery approach. In these particular examples, the alert modality is different from the presently employed content delivery modality, but will nevertheless stand out relative to the current modality and hence likely attract the attention of the end user in a desired manner.

As noted earlier, the aforementioned assessment of saliency can optionally take into account one or more ambient conditions as pertain to the end user content delivery platform itself. In such a case, and presuming to represent a device perceptual space vector (as corresponds to the environmental state of the device) as DPSV and a device contrast vector (as corresponds to the device state itself) as DCV, expression 1 can be modified as follows:

((CPSV@APSV@DPSV)*(CCV@ACV@DCV)) (2)

By this approach, for example, when the end user content delivery device is presently exposed to bright sunlight, this environmental condition can be taken into account to rate certain types of visual modalities that are likely to suffer under such ambient conditions as being less salient options.

If desired, this step of selecting 102 a particular alert modality as a function of saliency can further take into account one or more local ambient conditions as pertain to the given end user content delivery apparatus. Potentially useful ambient conditions to consider include, but are not limited to, local noise volume levels, local lighting levels, surfaces that the end user is presently in contact with, and so forth. Such ambient conditions can be determined using any of a variety of known sensors. Such information, in turn, can be used to further inform the aforementioned considerations regarding orthogonality and/or perceptual contrast. For example, while use of a sight-based alert modality is orthogonal to an audio-based content delivery modality, the former may nevertheless be useful when ambient light conditions are low and a very bright, blinking display may be reasonably expected to attract the attention of the end user notwithstanding such orthogonality.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

FIG. 2 illustrates two different platforms that can serve, individually or in tandem, as the aforementioned enabling platform. These are the end user content delivery apparatus 200 itself as well as the content server 204. Those skilled in the art will recognize that other apparatuses can be similarly usefully applied in this same manner if desired.

The end user content delivery apparatus 200 can comprise, for example, a hand-held, portable, wireless personal two-way communications device such as a broadband-capable cellular telephone or personal digital assistant as are known in the art. Other possibilities exist as well. In this illustrative embodiment the end user content delivery apparatus 200 comprises a processor 201 that operably couples to an end user content delivery interface 202. Those skilled in the art will recognize and appreciate that such a processor 201 can comprise a fixed-purpose hard-wired platform or can comprise a partially or wholly programmable platform. All of these architectural options are well known and understood in the art and require no further description here.

This end user content delivery interface 203 can be configured and arranged to selectively support a plurality of differing content perception modalities by which the apparatus 200 can present content to an end user of the apparatus 200. The processor 201, in turn, can be configured and arranged to selectively facilitate any of a plurality of available candidate different alert modalities that each serve to alert the end user regarding a change from a first one of the plurality of differing content perception modalities as is presently being used to present content to the end user to a second one of the plurality of differing content perception modalities.

By one approach, this processor 201 can be configured and arranged (via, for example, corresponding programming as will be well understood by those skilled in the art) to itself make a local decision regarding this selection of a particular one of the plurality of available candidate different alert modalities. This can comprise, for example, configuring and arranging the processor 201 to carry out one or more of the steps, actions, and functions described herein to effect this alert modality selection.

This can specifically comprise, for example, determining that the end user content delivery apparatus 200, which is presently delivering content via the end user content delivery interface using a first end user-perceivable modality is about to change to delivery of that substantive content using a second end user-perceivable modality that is different from the first end user-perceivable modality and then responsively and automatically selecting a particular alert modality, from amongst a plurality of available candidate different alert modalities, to be employed to alert the end user regarding the change in content delivery modalities. As described above, this selection can be based, at least in part, on a measure of saliency as pertains to each of the plurality of available candidate different alert modalities.

By another approach, at least part of the alert modality selection process can be carried out remotely to the end user content delivery apparatus 200. For example, the content server 204 itself can be applied in this regard. By this approach, a processor 205 as comprises a part of the content server 204 can be similarly configured and arranged as described above to carry out one or more of the steps, actions, or functions as are described herein. When this comprises having this processor 205 select the particular alert modality to be employed by the end user content delivery apparatus 200, this selection information can be conveyed via an end user content delivery apparatus interface 206 to the end user content delivery apparatus 200 as a remotely sourced alert modality selection message 207.

Those skilled in the art will recognize that the form of this message 207 as well as the components and operability of the end user content delivery apparatus interface 206 will vary with the application setting and that numerous known alternatives exist in this regard with other possibilities likely to be developed going forward. As but one illustrative, non-limiting example in this regard, this message 207 can employ, at least in part, Internet Protocol signaling formatting and the end user content delivery apparatus interface 206 can be configured and arranged to compatibly transceiver such signaling. As these various alternatives are well known in the art, for the sake of brevity further details in this regard will not be presented here.

As described above, these teachings will accommodate using information regarding ambient conditions that are local to the end user content delivery apparatus 200 when determining, for example, the aforementioned measure of saliency. To facilitate this optional approach, the end user content delivery apparatus 200 can further optionally comprise a source of ambient condition(s) information 203. This can comprise, in some cases, the original source of such information. In this case, this source 203 can comprise, for example, an ambient light sensor, an ambient temperature sensor, an ambient noise level sensor, and so forth. As another example, this source 203 may serve as a storage location for information that is originally sourced by another component (not shown). As but one example in this regard, this ambient condition information source 203 can have short range wireless communications capability (such as Bluetooth capability) that the source 203 employs to wirelessly receive ambient conditions information from other local devices such as local ambient light detectors, ambient noise level detectors, and so forth.

By one approach, this ambient condition information 203, when available, can be locally used by the end user content delivery apparatus 200 when determining a measure of saliency for the various candidate alert modalities as described above. By another approach, alone or in conjunction with the preceding, this ambient condition information 203 can be communicated, for example, to the content server 204 to thereby permit the latter to take such information into account when the content server 204 provides the alert modality selection functionality.

Those skilled in the art will recognize and understand that such an apparatus 200 and 204 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured and arranged, these teachings permit a highly flexible end user platform, which is capable of using any of a variety of content rendering modalities and of shifting between such modalities even while delivering a given item of substantive content, to provide a useful and efficacious alert to the corresponding end user when a shift in content delivery modality occurs. Those skilled in the art will recognize and appreciate that these teachings are readily leveraged using any of a wide variety of known technologies and methodologies and further that these teachings are readily scaled to accommodate, in a given application setting, a wide range of candidate alert modalities and/or saliency measurement criteria.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
determining that a given end user content delivery apparatus that is presently delivering content using a first end user-perceivable modality is about to change to delivery of the content using a second end user-perceivable modality that is different from the first end user-perceivable modality;
selecting a particular alert modality, from amongst a plurality of available candidate different alert modalities for the given end user content delivery apparatus, to be employed to alert the end user regarding a change from the first end user-perceivable modality to the second end user-perceivable modality as a function, at least in part, of a measure of saliency as pertains to each of the plurality of available candidate different alert modalities.

2. The method of claim 1 wherein the plurality of available candidate different alert modalities comprise, at least in part:
a plurality of different visually perceivable alert modalities;
a plurality of different audibly perceivable alert modalities;
a plurality of different haptically perceivable alert modalities.

3. The method of claim 1 wherein selecting a particular alert modality as a function, at least in part, of a measure of saliency as pertains to each of the plurality of available candidate different alert modalities comprises, at least in part, determining a measure of saliency for a given one of the available candidate different alert modalities as a function of the first end user-perceivable modality.

4. The method of claim 3 wherein selecting a particular alert modality as a function, at least in part, of a measure of saliency as pertains to each of the plurality of available candidate different alert modalities further comprises, at least in part, determining a measure of saliency for a given one of the available candidate different alert modalities as a function of the second end user-perceivable modality.

5. The method of claim 3 wherein determining a measure of saliency for a given one of the available candidate different alert modalities as a function of the first end user-perceivable modality comprises determining a measure of end user perceptual contrast for a given one of the available candidate different alert modalities as compared to the first end user-perceivable modality.

6. The method of claim 5 wherein determining a measure of end user perceptual contrast for a given one of the available candidate different alert modalities as compared to the first end user-perceivable modality comprises determining a measure of end user perceptual contrast at least for each of the available candidate different alert modalities that is non-orthogonal to the first end user-perceivable modality.

7. The method of claim 3 wherein selecting a particular alert modality as a function, at least in part, of a measure of saliency as pertains to each of the plurality of available candidate different alert modalities by, at least in part, determining a measure of saliency for a given one of the available candidate different alert modalities as a function of the first end user-perceivable modality comprises, at least in part:
selecting the particular alert modality to minimize orthogonality between the particular alert modality and the first end user-perceivable modality; and
selecting the particular alert modality to maximize end user perceptual contrast.

8. The method of claim 3 wherein determining a measure of saliency for a given one of the available candidate different alert modalities as a function of the first end user-perceivable modality comprises also determining the measure of saliency for a given one of the available candidate different alert modalities as a function of at least one local ambient condition as pertains to the given end user content delivery apparatus.

9. An apparatus comprising:
an end user content delivery apparatus interface;
a processor operably coupled to the end user content delivery apparatus interface and being configured and arranged to:
determine that a given end user content delivery apparatus that is presently delivering content using a first end user-perceivable modality is about to change to delivery of the content using a second end user-perceivable modality that is different from the first end user-perceivable modality;
select a particular alert modality, from amongst a plurality of available candidate different alert modalities for the given end user content delivery apparatus, to be employed to alert the end user regarding a change from the first end user-perceivable modality to the second end user-perceivable modality as a function, at least in part, of a measure of saliency as pertains to each of the plurality of available candidate different alert modalities.

10. The apparatus of claim 9 wherein the plurality of available candidate different alert modalities comprise, at least in part:
a plurality of different visually perceivable alert modalities;
a plurality of different audibly perceivable alert modalities;
a plurality of different haptically perceivable alert modalities.

11. The apparatus of claim 9 wherein the processor is configured and arranged to select a particular alert modality as a function, at least in part, of a measure of saliency as pertains to each of the plurality of available candidate different alert modalities by, at least in part, determining a measure of saliency for a given one of the available candidate different alert modalities as a function of the first end user-perceivable modality.

12. The apparatus of claim 11 wherein the processor is configured and arranged to determine a measure of saliency for a given one of the available candidate different alert modalities as a function of the first end user-perceivable modality by determining a measure of end user perceptual contrast for a given one of the available candidate different alert modalities as compared to the first end user-perceivable modality.

13. The apparatus of claim 12 wherein the processor is configured and arranged to determine a measure of end user perceptual contrast for a given one of the available candidate different alert modalities as compared to the first end user-perceivable modality by determining a measure of end user perceptual contrast at least for each of the available candidate different alert modalities that is non-orthogonal to the first end user-perceivable modality.

14. The apparatus of claim 11 wherein the processor is configured and arranged to determine a measure of saliency for a given one of the available candidate different alert modalities as a function of the first end user-perceivable modality by also determining the measure of saliency for a given one of the available candidate different alert modalities as a function of at least one local ambient condition as pertains to the given end user content delivery apparatus.

15. An end user content delivery apparatus comprising:
an end user content delivery interface being configured and arranged to selectively support a plurality of differing content perception modalities by which to present content to an end user;
a processor configured and arranged to selectively facilitate any of a plurality of available candidate different alert modalities that each serve to alert the end user regarding a change from a first one of the plurality of differing content perception modalities as is presently being used to present content to the end user to a second one of the plurality of differing content perception modalities.

16. The end user content delivery apparatus of claim 15 wherein the processor is further configured and arranged to use a particular one of the plurality of available candidate different alert modalities in a given instance as a function, at least in part, of a remotely sourced alert modality selection message.

17. The end user content delivery apparatus of claim 16 wherein the remotely sourced alert modality selection message identifies a specific category of alert modality and wherein the processor is further configured and arranged to select the particular one of the plurality of available candidate different alert modalities by making a local decision regarding a selection of a particular alert modality from amongst a plurality of the available candidate different alert modalities that match the specific category of alert modality.
